(19) United States
(12) Patent Application Publication
(10) Pub. No.: US 2021/0156784 A1
(43) Pub. Date: May 27, 2021

(54) PHOTOANALYSIS DEVICE, PHOTOANALYSIS METHOD AND NEURAL NETWORK SYSTEM

(71) Applicant: OLYMPUS CORPORATION, Tokyo (JP)

(72) Inventor: Takuya HANASHI, Tokyo (JP)

(73) Assignee: OLYMPUS CORPORATION, Tokyo (JP)

(21) Appl. No.: 17/143,571

(22) Filed: Jan. 7, 2021

Related U.S. Application Data
(63) Continuation of application No. PCT/JP2018/025861, filed on Jul. 9, 2018.

(51) Int. Cl. G01N 15/06; G01N 21/64

(52) U.S. Cl. CPC G01N 15/06; G01N 2015/0693; G01N 2021/6439; G01N 21/6428

(57) ABSTRACT

A photoanalysis device includes: an optical system that scans a sample solution to detect light-emitting particles that are scattered in a sample solution and move randomly; a light detection data input part into which light detection data, which is a result of detection of the light-emitting particles by the optical system, is input; a signal processor that generates time-series light intensity data from the light detection data; a concentration calculator that calculates a concentration of the light-emitting particles detected by the optical system, from the time-series light intensity data generated by the signal processor, on the basis of a learned model learned about a relationship between a plurality of time-series light intensity data having different measurement conditions and a concentration of the light-emitting particles; and a concentration output part that outputs a calculation result of the concentration calculator.

### CROSS REFERENCE TO RELATED APPLICATIONS

This application is a continuation application based on a PCT Patent Application No. PCT/JP2018/025861, filed on Jul. 9, 2018, the entire content of which is hereby incorporated by reference.

### BACKGROUND OF THE INVENTION

### Field of the Invention

The present invention relates to a photoanalysis device, a photoanalysis method and a neural network system. The photoanalysis technique used for these uses an optical system that can detect light from a minute region in a solution, such as an optical system of a confocal microscope or a multiphoton microscope. This optical system detects light from atoms, molecules or aggregates thereof (hereinafter referred to as “particles”) scattered or dissolved in a solution, biomolecules such as proteins, peptides, nucleic acids, lipids, sugar chains, amino acids or or aggregates thereof, particulate objects such as viruses, cells, or non-biological particles dispersed or dissolved in solution. Information useful in the analysis or analysis of those states (interaction, bond/dissociation state, etc.) can be obtained. More specifically, the present invention provides a photoanalysis device, a photoanalysis method and a neural network system that enables various optical analyzes by individually detecting light from a single light emitting particle using an optical system as described above. In addition, in this specification, a particle which emits light (hereinafter, referred to as a “light emitting particle”) may be either a particle which emits light by itself, or a particle to which an arbitrary light emitting label or a light emitting probe is attached. The light emitted from the light-emitting particles may be fluorescence, phosphorescence, chemiluminescence, bioluminescence, scattered light or the like.

### Description of the Related Art

Recent optical measurement technology uses the optical system of a confocal microscope and an ultrasensitivelight detection technology capable of photon counting (single photon detection). This makes it possible to detect and measure weak light at the level of one photon or one fluorescent molecule. Therefore, various devices/methods have been proposed for detecting the characteristics of biomolecules, intermolecular interactions, or bond/dissociation reactions by using such weak light measurement technology.

According to a method using a micro-region fluorescence measurement technique using the optical system of a confocal microscope such as Fluorescence Correlation Spectroscopy (FCS) and Fluorescence-Intensity Distribution Analysis (FIDA) and photon counting technology, the sample required for measurement may have an extremely low concentration and a very small amount as compared with the conventional one (the amount used in one measurement is at most several tens of μL), and the measurement time is significantly shortened. (Measurement of time on the order of seconds is repeated several times in one measurement). Therefore, these techniques are effective especially for the analysis of rare or expensive samples often used in the field of medical and biological research and development, or when the number of samples is large as clinical diagnosis of diseases and screening of physiologically active substances. That is, these techniques are expected to be powerful tools that can carry out experiments or tests at low cost or quickly as compared with conventional biochemical methods.

PCT International Publication No. WO 2011-108371 (hereinafter referred to as Patent Document 1) describes a photoanalysis technique. This is based on the principle that the concentration or number concentration of the light-emitting particles to be observed makes it possible to quantitatively observe the state or characteristics of the light-emitting particles in the sample solution, which is lower than the level handled by photoanalytical techniques including statistical processing such as FCS and FIDA. The photoanalysis technique described in Patent Document 1 uses an optical system capable of detecting light from a minute region in a solution, such as an optical system of a confocal microscope or a multiphoton microscope, similar to FCS, FIDA, and the like. Then, the inside of the sample solution is scanned by the light detection region while moving the position of the minute region (hereinafter, referred to as “light detection region”) which is the light detection region in the sample solution. Further, the photoanalysis technique described in Patent Document 1 detects the light emitted from the light emitting particles when the light detection region contains the light emitting particles scattered in the sample solution and moving randomly. As a result, each of the light-emitting particles in the sample solution is individually detected, and information on the counting of the light-emitting particles and the concentration or number concentration of the light-emitting particles in the sample solution is acquired. According to this photoanalysis technique (hereinafter referred to as “scanning molecule counting method”), the amount of sample required for measurement may be very small (for example, about several tens of μL) as in the case of photoanalysis techniques such as FCS and FIDA. In addition, the scanning molecule counting method has a short measurement time. Moreover, the scanning molecule counting method detects the presence of light-emitting particles having a lower concentration or a number concentration than in the case of photoanalysis techniques such as FCS and FIDA. The scanning molecule counting method can quantitatively detect its concentration, number concentration or other properties.

In the above scanning molecule counting method, the light intensity value (or photon count value) is measured while moving the position of the light detection region in the sample solution. In the time-series data of this light intensity value (or photon count value), when an increase in light intensity corresponding to light from light-emitting particles (typically, a bell-shaped profile) is observed, it is determined that one light-emitting particle is included in the light detection region. As a result, the presence of one light-emitting particle is detected. In this configuration, the actual time-series light intensity data includes noise (thermal noise of the light detector, background light) in addition to the light from the light-emitting particles. Therefore, it is necessary to eliminate noise and detect the presence of a signal representing light from light-emitting particles (signal of light-emitting particles). Therefore, typically, extraction of the signal of the light-emitting particles is attempted with reference to the characteristics of the signal of the light-emitting particles, for example, the magnitude of the intensity, the shape of the signal, and the like. In this regard, the signal characteristics of light-emitting particles and the magnitude and shape of noise differ depending on the measurement conditions (diffusion time of molecular species, brightness, presence/absence of non-analyzed objects, scanning period, excitation wavelength, excitation intensity, observation wavelength, etc.) Therefore, the identification conditions for the photon count signal differ depending on the measurement conditions. Therefore, it is necessary to set the analysis parameters according to the measurement conditions.

In particular, it is difficult to control measurement conditions such as dust contamination, fluctuations in excitation intensity and dark current, and differences between containers for autofluorescence. Therefore, if the S/N discriminating ability is enhanced under such measurement conditions, reproducibility tends to be poor. Therefore, it is necessary to be able to suitably detect the signal of the light-emitting particles even under such measurement conditions. Therefore, a robust photoanalysis device, photoanalysis method, and learned model that have high S/N discrimination ability and can ensure reproducibility are desired.

### SUMMARY

The present invention provides a robust photoanalysis device, photoanalysis method, and learned model having high S/N discriminating ability in the scanning molecule counting method.

A photoanalysis device comprising: an optical system that scans a sample solution to detect light-emitting particles that are scattered in a sample solution and move randomly; a light detection data input part into which light detection data, which is a result of detection of the light-emitting particles by the optical system, is input; a signal processor that generates time-series light intensity data from the light detection data; a concentration calculator that calculates a concentration of the light-emitting particles detected by the optical system, from the time-series light intensity data generated by the signal processor, based on a learned model learned about a relationship between a plurality of time-series light intensity data having different measurement conditions and a concentration of the light-emitting particles; and a concentration output part that outputs a calculation result of the concentration calculator.

The signal processor generates two-dimensional time-series light intensity data arranged in time order in one-dimensional direction and periodic order in two-dimensional direction from the time-series light intensity data, and the learned model of the concentration calculator inputs the two-dimensional time-series light intensity data.

In the above photoanalysis device, the learned model may be composed of a neural network, the neural network may input the time series light intensity data, and the neural network may output the concentration of the light-emitting particles.

In the above photoanalysis device, the neural network may be a convolutional neural network, and the two-dimensional time-series light intensity data may be input to the convolutional neural network as an image.

The above photoanalysis device may further comprises: a measurement condition input part that inputs a measurement condition when the light detection data is detected, wherein the learned model may have been learned regarding a relationship between the time-series light intensity data, the measurement condition, and the concentration of the light-emitting particles, and the concentration calculator may calculate the concentration of the light-emitting particles from the time-series light intensity data and the measurement conditions based on the learned model.

In the above photoanalysis device, the measurement condition may be at least one of diffusion time, brightness, presence/absence of non-analyzed object, scanning period, excitation wavelength, excitation intensity, and observation wavelength of the molecular species.

A photoanalysis method comprising: a scanning detection step that detects light-emitting particles scattered in a sample solution and moving randomly by scanning an optical system; a time-series light intensity data generation step that generates time-series light intensity data from a light detection data which is a detection result of the light-emitting particles; a time-series light intensity data two-dimensional step that generates two-dimensional time-series light intensity data arranged in time order in a one-dimensional direction and periodic order in a two-dimensional direction from the time-series light intensity data; and a concentration calculation step that calculates a concentration of the light-emitting particles from the time-series light intensity data based on a learned model learned about a relationship between a plurality of the time-series light intensity data having different measurement conditions and the concentration of the light-emitting particles.

The above photoanalysis method may further comprises: a measurement condition input step in which a measurement condition when the light detection data is detected is input, wherein the learned model may have been learned regarding a relationship between the time-series light intensity data, the measurement condition, and the concentration of the light-emitting particles, and the concentration calculation step may calculate the concentration of the light-emitting particles from the time-series light intensity data and the measurement condition based on the learned model.

A neural network system capable of executing a learned model for operating a computer to output a concentration of light-emitting particles based on time-series light intensity data of the light-emitting particles, wherein the learned model consists of a convolutional neural network, two-dimensional time-series light intensity data generated from the time-series light intensity data and arranged in time order in one-dimensional direction and periodic order in two-dimensional direction is input as an image to an input layer of the convolutional neural network, and the concentration of the light-emitting particles is output from an output layer of the convolutional neural network.

In the above neural network system, the learned model may make a computer function so as to input the two-dimensional time series light intensity data and a measurement condition of the light-emitting particles into the input layer and output the concentration of the light-emitting particles from the output layer.

According to the photoanalysis device, the photoanalysis method, and the neural network system of the present invention, it is possible to detect a signal of light-emitting particles having high S/N discrimination ability and robustness in the scanning molecule counting method.

### BRIEF DESCRIPTION OF THE DRAWINGS

FIG. 1 shows an overall configuration of a photoanalysis device according to a first embodiment of the present invention.

FIG. 2 is a schematic diagram showing a principle of light detection in a scanning molecule counting method performed by the photoanalysis device, and a schematic diagram of a time change of a measured light intensity.

FIG. 3 is a functional block diagram of a computer of the photoanalysis device.

FIG. 4 is time-series light intensity data generated by the signal processor of the photoanalysis device.

FIG. 5 is a two-dimensional time-series light intensity data obtained by converting the one-dimensional time-series light intensity data shown in FIG. 4.

FIG. 6 is a constructive conceptual diagram of a learned model of a computer of the photoanalysis device.

FIG. 7 is a functional block diagram of a computer of the photoanalysis device according to a second embodiment of the present invention.

FIG. 8 shows the measurement results according to Example 1 in Examples.

FIG. 9 shows the measurement results according to Comparative Example 1 in Examples.

FIG. 10 shows the measurement results according to Example 2 in Examples.

FIG. 11 shows the measurement results according to Comparative Example 2 in Examples.

### DETAILED DESCRIPTION OF THE PREFERRED EMBODIMENTS

### First Embodiment

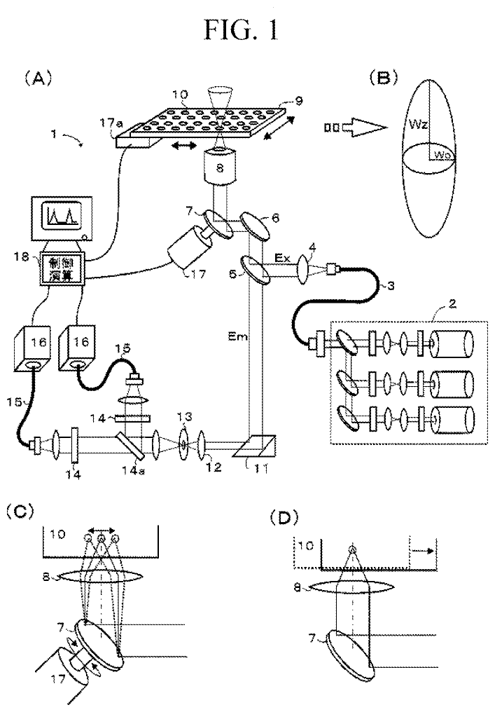

A first embodiment of the present invention will be described with reference to FIG. 1.

FIG. 1 shows an overall configuration of a photoanalysis device 100 according to the present embodiment.

(Structure of Photoanalysis Device 100)

The photoanalysis device 100 is a device in which an optical system of a confocal microscope capable of executing FCS, FIDA, etc. and a light detector are combined in a basic configuration, as schematically shown in FIG. 1(A). This is a device that performs photoanalysis by the scanning molecule counting method. The photoanalysis device 100 includes optical systems 2 to 17 and a computer 18 that controls the operation of each part of the optical system and acquires and analyzes data.

The optical system of the photoanalysis device 100 may be the same as the optical system of a normal confocal microscope. The laser beam (Ex) is emitted from the light source 2 and propagates in the single mode fiber 3. This laser light (Ex) is emitted as light emitted at an angle determined by a unique NA at the exit end of the fiber. Then, it becomes parallel light by the collimator 4, is reflected by the dichroic mirrors 5 and the reflection mirrors 6 and 7, and is incident on the objective lens 8.

Above the objective lens 8, typically, a sample container into which 1 to several tens of μL of the sample solution is dispensed or a microplate 9 in which the wells 10 are arranged is arranged. The laser light emitted from the objective lens 8 is focused in the sample solution in the sample container or the well 10, and a region (excitation region) having a strong light intensity is formed. In the sample solution, light-emitting particles to be observed, typically particles to which a light-emitting label such as a fluorescent particle or a fluorescent dye is added, are scattered or dissolved. When such light-emitting particles enter the excitation region, the light-emitting particles are excited and light is emitted during that time.

The emitted light (Em) passes through the objective lens 8 and the dichroic mirror 5 and is reflected by the mirror 11. Then, the light is collected by the condenser lens 12, passes through the pinhole 13, and passes through the barrier filter 14. Here, only the light component of a specific wavelength band is selected. It is introduced into the multimode fiber 15 to reach the light detector 16. Then, this is converted into a time-series electric signal (light detection data), and then input to the computer 18.

The computer 18 is a program-executable device including a CPU (Central Processor), a memory, a storage, and an input/output controller. By executing a predetermined program, it functions as a plurality of functional blocks such as the concentration calculator 23, which will be described later. The computer 18 is connected to an input part (not shown) such as a keyboard or mouse and a display 18d such as an LCD monitor.

As is known to those skilled in the art, in the above configuration, the pinhole 13 is arranged at a position conjugate with the focal position of the objective lens 8. As a result, only the light emitted from the focal region of the laser beam schematically shown in FIG. 1(B), that is, the excitation region passes through the pinhole 13. As a result, light from other than the excited region is blocked. The focal region of the laser beam illustrated in FIG. 1(B) is usually a light detection region in the present photoanalysis device having an effective volume of about 1 to 10 fL. Typically, the light intensity has a Gauss-like distribution with the center of the region as the apex, and the effective volume is the volume of a substantially elliptical sphere whose boundary is a surface having a light intensity of 1/e2. This is called the confocal volume.

In the photoanalysis device 100, light from one light-emitting particle, for example, weak light from one fluorescent dye molecule is detected. Therefore, as the light detector 16, an ultrasensitive light detector that can be used for photon counting is preferably used.

In the optical system of the photoanalysis device 100, the inside of the sample solution is scanned by the light detection region. That is, a mechanism for moving the position of the light detection region in the sample solution is provided. As a mechanism for moving the position of the light detection region, for example, a mirror deflector 17 that changes the direction of the reflection mirror 7 may be adopted as schematically illustrated in FIG. 1(C). This is a method of moving the absolute position of the light detection region. Such a mirror deflector 17 may be similar to a galvanometer mirror device equipped in a normal laser scanning microscope. Alternatively, as another embodiment, as illustrated in FIG. 1(D), the horizontal position of the container 10 (microplate 9) in which the sample solution is injected is moved, and the relative light detection region in the sample solution is moved. The stage position changing device 17a may be operated in order to move the desired position. This is a method of moving the absolute position of the sample solution. In either method, the mirror deflector 17 or the stage position changing device 17a is driven under the control of the computer 18 in cooperation with the light detection by the light detector 16, in order to achieve the desired movement pattern of the position of the light detector region. The movement locus of the position of the light detection region may be arbitrarily selected from a circle, an ellipse, a rectangle, a straight line, a curve, or a combination thereof. That is, various movement patterns may be selectable in the program executed by the computer 18. Although not shown, the position of the light detection region may be moved in the vertical direction by moving the objective lens 8 or the stage up and down.

The photoanalysis device 100 moves the light detector region at a constant scanning cycle. The movement pattern of the light detection region is the same for each scanning cycle.

When the light-emitting particles to be observed emit light due to multiphoton absorption, the above optical system is used as a multiphoton microscope. In that case, the pinhole 13 may be removed because the light is emitted only in the focal region (light detection region) of the excitation light. Further, when the light-emitting particles to be observed emit light regardless of the excitation light due to chemiluminescence or bioluminescence phenomenon, the optical systems 2 to 5 for generating the excitation light may be omitted. When the light-emitting particles emit light by phosphorescence or scattering, the optical system of the confocal microscope described above is used as it is. Further, in the photoanalysis device 100, as shown in FIG. 1, a plurality of light sources 2 may be provided. The wavelength of the excitation light may be appropriately selected depending on the excitation wavelength of the light-emitting particles. Similarly, a plurality of light detectors 16 may be provided. When a sample contains a plurality of types of light-emitting particles having different wavelengths, light may be detected separately according to the wavelength. Further, regarding the detection of light, light polarized in a predetermined direction is used as the excitation light, and a component in the direction perpendicular to the polarization direction of the excitation light may be selected as the detection light. In that case, a polarizer (not shown) is inserted into the excitation optical path, and a polarizing beam splitter 14a is inserted into the detection optical path. According to such a configuration, it is possible to significantly reduce the background light in the detection light.

(Scanning Molecule Counting Method)

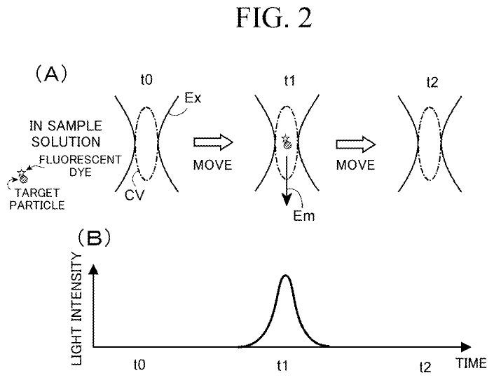

The photoanalysis device 100 that performs photoanalysis by the scanning molecule counting method drives a mechanism (mirror deflector 17 or a stage position changing device 17a) for moving the position of the optical detection region to change the optical path. Alternatively, the horizontal position of the container 10 (microplate 9) in which the sample solution is injected is moved. As schematically depicted in FIG. 2(A), light detection is performed while moving the position of the light detection region CV in the sample solution, that is, scanning the sample solution with the light detection region CV (Scan detection step). For example, while the light detection region CV moves (time t0 to t2 in the figure), when passing through the region where one light-emitting particle exists (a), light is emitted from the light-emitting particle. Then, a pulse-shaped signal having a significant light intensity (Em) appears on the time-series light intensity data as shown in FIG. 2(B).

The device described in Patent Document 1 of the prior art document performs the above-mentioned movement of the position of the light detection region CV and light detection. The pulsed signals (significant light intensity) appearing in the meantime as illustrated in FIG. 2(B) are detected one by one. Emission particles are individually detected from the detected pulsed signal. By counting the number, information on the number, concentration or number concentration of light-emitting particles existing in the measured region is acquired. In the principle of the scanning molecule counting method, statistical calculation processing such as calculation of the fluctuation of fluorescence intensity is not performed. Luminous particles are detected one by one. Therefore, it is possible to obtain information on the concentration or number concentration of particles even in a sample solution having a low concentration of particles to be observed so that analysis cannot be performed with sufficient accuracy by FCS, FIDA or the like.

The photoanalysis device 100 of the present embodiment performs photoanalysis by the following new photoanalysis method without detecting the pulsed signal as illustrated in FIG. 2(B).

(Photoanalysis Method)

Next, the photoanalysis method of the light detection data executed by the photoanalysis device 100 will be described.

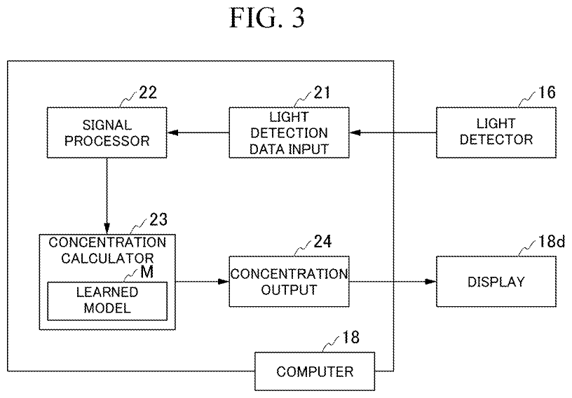

FIG. 3 is a functional block diagram of the computer 18.

The computer 18 includes an optical detection data input part 21, a signal processor 22, a concentration calculator 23, and a concentration output part 24. The function of the computer 18 is realized by the computer 18 executing the photoanalysis program provided to the computer 18.

The light detector 16 inputs the light detection data, which is the detection result of the emitted light (Em), to the light detector data input part 21. The light detection data input part 21 temporarily stores the light detection data for a predetermined period, for example, the light detection data that can be acquired by scanning one cycle in the scanning molecule counting method for a plurality of cycles. Then, the stored light detection data for a plurality of cycles is output to the signal processor 22.

The signal processor 22 generates time-series light intensity data from the light detection data input to the light detection data input part 21 (time-series light intensity data generation step). When the detection of light by the light detector 16 is photon counting, the measurement by the light detector 16 is performed in a mode of sequentially measuring the number of photons, which arrives at the light detector 16 in a predetermined unit time (BIN TIME), over a predetermined time. In this case, the time-series light intensity data generated by the signal processor 22 becomes the time-series photon count data.

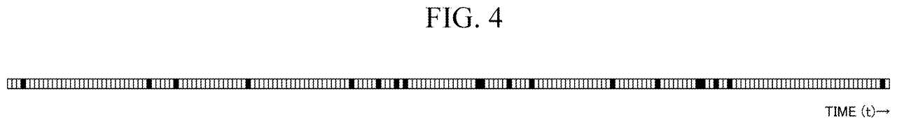

FIG. 4 is time-series light intensity data generated by the signal processor 22. The light intensity data shown in black indicates that light was detected, and the light intensity data shown in white indicates that light was not detected.

In addition to the light from the light-emitting particles, noise (thermal noise of the light detector, background light) exists on the time-series light intensity data. The signal characteristics of the light-emitting particles and the magnitude and shape of the noise differ depending on the measurement conditions (diffusion time and brightness of the molecular species, presence/absence of non-analyzed objects, scanning period, excitation wavelength, excitation intensity, observation wavelength, etc.). In the light intensity data shown in FIG. 4, there is a possibility that noise is included in the light intensity data shown in black.

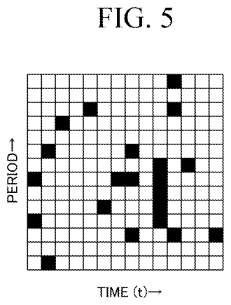

The signal processor 22 converts the generated time-series light intensity data (one-dimensional) into two-dimensional time-series light intensity data (time-series light intensity data two-dimensional step). FIG. 5 is a two-dimensional time-series light intensity data obtained by converting the one-dimensional time-series light intensity data shown in FIG. 4. The two-dimensional time-series light intensity data is obtained by dividing the one-dimensional time-series light intensity data detected while scanning the sample solution for each scanning cycle, and arranging the divided light intensity data in the two-dimensional direction to make it two-dimensional. In the two-dimensional time-series light intensity data, the one-dimensional direction indicates the time axis, and the two-dimensional direction indicates the number of periods. That is, in the two-dimensional time-series light intensity data, the light intensity data are arranged in the time order in the one-dimensional direction and in the periodic order in the two-dimensional direction. The light intensity data in the one-dimensional direction adjacent to each other in the two-dimensional direction is the light intensity data having a continuous period. The signal processor 22 outputs the generated time-series light intensity data to the concentration calculator 23.

For example, when BIN TIME generates 10 us two-dimensional time-series light intensity data from 1-second light detection data scanned in a sample solution with a scanning period of 6.66 ms (scanning speed 9000 RPM), the time is two-dimensional. In the serial light intensity data, 666 light intensity data are arranged in the one-dimensional direction, and 150 cycles of time-series light intensity data are arranged in the two-dimensional direction. The light intensity data adjacent to each other in the two-dimensional direction is the light intensity data detected in the same light detection region in a continuous cycle.

The concentration calculator 23 calculates the concentration of light-emitting particles from the time-series light intensity data based on the “learned model M” (concentration calculation step). The learned model M is a Convolutional Neural Network (CNN) that inputs two-dimensional time-series light intensity data, which is input from the signal processor 22, as an image (for example, a grayscale image), and outputs outputs the concentration of light-emitting particles. The learned model M is used as a program module of a part of the photoanalysis program executed by the computer 18 of the photoanalysis device 100. The computer 18 may have a dedicated logic circuit or the like for executing the learned model M.

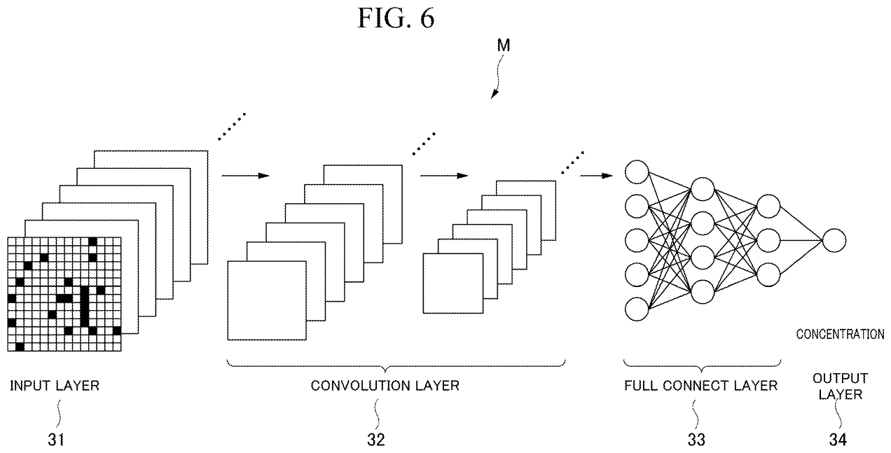

FIG. 6 is a constructive conceptual diagram of the learned model M.

The learned model M includes an input layer 31, a convolution layer 32, a fully connected layer 33, and an output layer 34.

The input layer 31 receives time-series light intensity data input from the signal processor 22. The input layer 31 receives the two-dimensional time-series light intensity data as an image and outputs it to the convolution layer 32. The plurality of two-dimensional time-series light intensity data are sequentially input to the convolution layer 32.

The convolution layer 32 includes a plurality of filter layers and pooling layers. The filter layer performs an image convolution operation by the learned filter processing obtained by the learning. The activation function of the node of the filter layer is a ReLU (Rectified Linear Unit) function or a Leaky ReLU function. The pooling layer performs filtering to reduce resolution. The pooling layer has a dimension reduction function that reduces the amount of information while retaining its characteristics. The convolution layer 32 can spatially extract the characteristics of the light-emitting particles from the image by alternately repeating the filter layer and the pooling layer.

The fully connected layer 33 is a neural network including a plurality of layers and in which the nodes of the previous and next layers are all connected to each other. The output of the convolution layer 32 is coupled to the fully connected layer 33, and an operation based on a learned weighting coefficient, an activation function, or the like is performed, and the operation result is output to the output layer 34, which is one node. The activation function of the node of the fully connected layer 33 is a ReLU function or a Leaky ReLU function.

The output layer 34 calculates the concentration (scalar value) from the calculation result input from the fully connected layer 33 based on the learned function. The activation function of the node of the output layer 34 is the ReLU function. The output layer 34 outputs the calculated concentration to the concentration output part 24.

The concentration output part 24 outputs the concentration input from the output layer 34 to the display 18d. The display 18d displays the input concentration.

(Generation of Learned Model)

The learned model M is generated by prior learning based on the teacher data described later. The learned model M may be generated by the computer 18 of the photoanalysis device 100, or may be performed by using another computer having a higher computing power than the computer 18.

The learned model M is generated by supervised learning by the well-known technique of error backpropagation (backpropagation). As a result, the filter configuration of the filter layer and the weighting coefficient between neurons (nodes) are updated.

In the present embodiment, two-dimensional time-series light intensity data is generated from the light detection data obtained by detecting a sample solution having a known concentration by a scanning molecule counting method in the same manner as the method performed by the signal processor 22. The combination of the generated two-dimensional time-series light intensity data and the known concentration is the teacher data.

It is desirable to prepare training data as diverse as possible by changing the concentration and measurement conditions (diffusion time of molecular species, brightness, presence/absence of non-analyzed objects, scanning period, excitation wavelength, excitation intensity, observation wavelength, etc.). In particular, by preparing teacher data under various measurement conditions, it is possible to generate a learned model M that has high S/N discrimination ability against noise generated under various measurement conditions and capable of robust concentration calculation.

The computer 18 inputs the two-dimensional time-series light intensity data of the teacher data to the input layer 31. The filter configuration of the filter layer and the weighting coefficient between neurons (nodes) is learned so that the concentration of the input teacher data is output from the output layer 34 and the mean square error between the concentration of the teacher data and the output concentration of the output layer becomes small.

According to the photoanalysis device 100 of the present embodiment, in the scanning molecule counting method, it is possible to detect a signal of light-emitting particles having high S/N discrimination ability and robustness.

According to the photoanalysis device 100 of the present embodiment, a convolutional neural network is used for the learned model M, and two-dimensional time-series light intensity data is used for the input of the learned model M. The two-dimensional time-series light intensity data are arranged in the time order in the one-dimensional direction and in the periodic order in the two-dimensional direction. Therefore, the photoanalysis device 100 can easily spatially extract the characteristics of the light-emitting particles. In addition, the spatial characteristics of the light-emitting particles can be suitably extracted by a convolutional neural network.

In addition, the photoanalysis device 100 can easily extract spatial features of noise included in time-series light intensity data. For example, when the sample solution contains a non-analyzed object, the noise caused by the non-analyzed object is likely to be generated periodically in the time-series light intensity data acquired by scanning. Such periodic noise is easy to extract as a spatial feature in two-dimensional time-series light intensity data. Therefore, the photoanalysis device 100 can easily eliminate the influence of such noise. As a result, the photoanalysis device 100 can easily extract the spatial features of the light-emitting particles.

Although the first embodiment of the present invention has been described in detail with reference to the drawings, the specific configuration is not limited to this embodiment and includes design changes and the like within a range not deviating from the gist of the present invention. In addition, the components shown in the above-described first embodiment and the modifications shown below can be appropriately combined and configured.

(Modification 1)

For example, in the above embodiment, the light detection data input part 21, the signal processor 22, the concentration calculator 23, and the concentration output part 24 are realized by the functions of software running on the computer 18. However, the configuration of these functional blocks is not limited to this. For example, at least some functional blocks may be composed of dedicated hardware.

(Modification 2)

For example, in the above embodiment, the learned model M is a convolutional neural network having an input layer 31, a convolution layer 32, a fully connected layer 33, and an output layer 34. However, the mode of the learned model M is not limited to this. For example, the learned model M may have a non-fully connected layer instead of the fully connected layer 33. Further, the output layer may have a mode in which the Softmax function is used as an activation function and the concentration is clustered.

(Modification 3)

For example, in the above embodiment, the learned model M is generated by pre-learning. However, the method of generating the learned model M is not limited to this. The learning model may be updated at any time after learning. The learned model may be additionally learned using the newly obtained data as teacher data.

(Modification 4)

For example, in the above embodiment, the time-series light intensity data is data, and the two-dimensional time-series light intensity data is an image. However, the format of time series light intensity data is not limited to this. For example, the light intensity data may be a scalar value corresponding to the photon count value, and the two-dimensional time-series light intensity data generated from the scalar value may be a grayscale image.

(Modification 5)

For example, in the above embodiment, the learned model M is a neural network. However, the mode of the learned model is not limited to this. The learned model may be a model learned by supervised machine learning such as support vector machine (SVM) linear regression, logistic regression, decision tree, regression tree, and random forest.

### Second Embodiment

A second embodiment of the present invention will be described with reference to FIG. In the following description, the same reference numerals will be given to the configurations common to those already described, and a duplicate description will be omitted.

The photoanalysis device 100B according to the second embodiment has a different computer functional configuration as compared with the photoanalysis device 100 according to the first embodiment.

The photoanalysis device 100B is the same as the photoanalysis device 100 of the first embodiment, except that the computer 18 is replaced by the computer 18B.

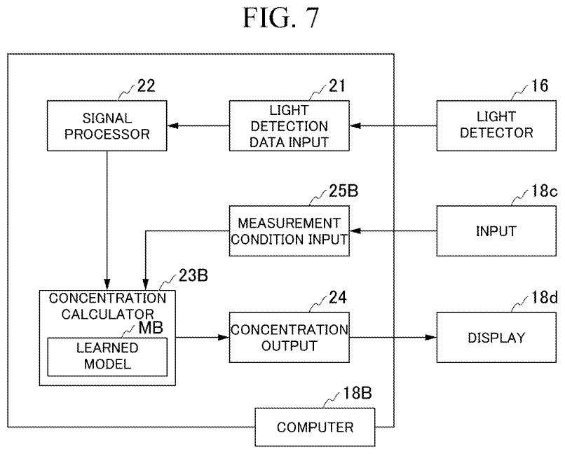

FIG. 7 is a functional block diagram of the computer 18B.

The computer 18B includes alight detection data input part 21, a signal processor 22, a concentration calculator 23B, a concentration output part 24, and a measurement condition input part 25B. The function of the computer 18B is realized by the computer 18B executing the photoanalysis program provided to the computer 18B.

The computer 18B is a program-executable device including a CPU (Central Processor), a memory, a storage, and an input/output controller. By executing a predetermined program, it functions as a plurality of functional blocks such as the concentration calculator 23. As shown in FIG. 7, the computer 18 is connected to an input part 18c such as a keyboard and a mouse and a display 18d such as an LCD monitor.

In the measurement condition input part 25B, the measurement conditions acquired by the light detection data input to the light detection data input part 21 are input by the user from the input part 18c (measurement condition input step). The input measurement conditions are the diffusion time of the molecular species, brightness, presence/absence of non-analyzed object, scanning period, excitation wavelength, excitation intensity, observation wavelength, and the like. The measurement condition input part 25B outputs the input measurement condition to the concentration calculator 23B.

The concentration calculator 23B calculates the concentration of the light-emitting particles from the time-series light intensity data and the measurement conditions based on the “learned model MB” (concentration calculation step). The learned model MB is a convolutional neural network that inputs the two-dimensional light intensity data input from the signal processor 22 as an image, further inputs the measurement conditions input from the measurement condition input part 25B, and outputs the concentration of the light-emitting particles. The learned model MB is used as a program module of a part of the photoanalysis program executed by the computer 18B of the photoanalysis device 100B.

The learned model MB is a convolutional neural network that inputs not only the time-series light intensity data input from the signal processor 22 but also the measurement conditions input from the measurement condition input part 25B. By inputting the measurement conditions, it becomes easy to extract the characteristics of the light-emitting particles for each measurement condition.

The learned model MB is generated by supervised learning by the error backpropagation method (backpropagation) as in the learned model M of the first embodiment.

In the present embodiment, two-dimensional time-series light intensity data is generated from the light detection data obtained by detecting a sample solution having a known concentration by a scanning molecule counting method in the same manner as the method performed by the signal processor 22. The combination of the generated two-dimensional time-series light intensity data, the known concentration, and the measurement conditions at the time of acquiring the light detection data is the teacher data.

According to the photoanalysis device 100B of the present embodiment, it is possible to detect a signal of light-emitting particles having high S/N discrimination ability and robustness in the scanning molecule counting method.

According to the photoanalysis device 100B of the present embodiment, a convolutional neural network is used for the learned model MB, and two-dimensional time-series light intensity data and measurement conditions are used for input of the learned model MB. The two-dimensional time-series light intensity data are arranged in the time order in the one-dimensional direction and in the periodic order in the two-dimensional direction. Therefore, the photoanalysis device 100 can easily spatially extract the characteristics of the light-emitting particles for each measurement condition. In addition, the spatial characteristics of the light-emitting particles can be suitably extracted by a convolutional neural network.

Further, the photoanalysis device 100B can easily extract the spatial characteristics of noise included in the time-series light intensity data. For example, noise caused by measurement conditions is likely to occur periodically in time-series light intensity data acquired by scanning Such periodic noise is easy to extract as a spatial feature in two-dimensional time-series light intensity data. Therefore, the photoanalysis device 100B can easily eliminate the influence of noise caused by such measurement conditions. As a result, the photoanalysis device 100B can easily extract the spatial features of the light-emitting particles.

Although the second embodiment of the present invention has been described in detail with reference to the drawings, the specific configuration is not limited to this embodiment and includes design changes and the like within a range not deviating from the gist of the present invention. In addition, the components shown in the above-described second embodiment and modified examples of the first embodiment can be appropriately combined and configured.

### EXAMPLE

Hereinafter, the present invention will be described in detail based on examples, but the technical scope of the present invention is not limited to these examples.

### Example 1

Example 1 is the photoanalysis device 100 of the first embodiment. The photoanalysis device 100 is set to operate at an excitation wavelength of 642 nm, an excitation intensity of 1 mW, an observation wavelength of 660 nm to 710 nm, and a scanning period of 6.66 ms (scanning speed of 9000 RPM). Further, in the photoanalysis device 100, the BIN TIME is set to 10 us. From the light intensity data every second, it is set to generate two-dimensional time-series light intensity data in which 666 pieces are arranged in the one-dimensional direction and 150 cycles are arranged in the two-dimensional direction.

(Learned Model M)

The convolution layer 32 of the learned model M of the photoanalysis device 100 includes two filter layers and two pooling layers, respectively. The filter layer and the pooling layer are arranged alternately. The activation function of the node is the Leaky ReLU function. In the filter layer, the input image is filtered to generate 16 types of images. The stride width of the filtering process is set to 1 pixel.

The fully connected layer 33 of the learned model M is composed of 6 layers. The activation function is the Leaky ReLU function. The activation function of the output layer 34 is the ReLU function, and the concentration (scalar value) is output.

(Teacher Data)

As teacher data, 3 samples were prepared by diluting ATTO647N to 10 fM, 32 fM, and 100 fM using 10 mM, Tris-HCl 0.05%, and purronic F127. In addition, 9 samples including 3 samples of 10 mM, 3 samples of Tris-HCl 0.05%, and 3 samples of pluronic F127 were prepared as teacher data at a concentration of 0 M. There are a total of 12 samples.

Each of the above 12 samples was measured for 200 seconds by the photoanalysis device 100. The 200-second time-series light intensity data of each sample was divided into 200 time-series light intensity data per second. The 100 time-series light intensity data were used as teacher data, and the remaining 100 were used as verification data.

(Learning of Learned Model M)

The learned model M was learned in advance using the above teacher data. The batch size was set to 32, mean squared error was used as the error function, and Adam was used as the optimization algorithm.

### Comparative Example 1

Comparative Example 1 is a device described in Patent Document 1, which is a prior art document. This device is set to operate in the same manner as the photoanalysis device 100 except for the photoanalysis method by a computer.

(Verification Result)

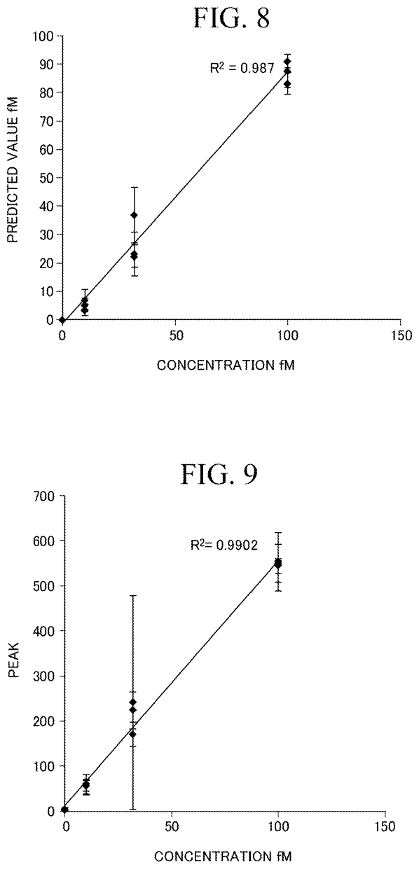

Using the above verification data, the concentration was measured and verified in Example 1 and Comparative Example 1. FIG. 8 shows the measurement results according to Example 1. FIG. 9 shows the measurement results according to Comparative Example 1. The measurement result according to Example 1 shows high linearity. Compared with the measurement result of Comparative Example 1, the standard deviation at 10 fM was smaller, and it was confirmed that the measurement reproducibility was high.

### Example 2

Example 2 is the photoanalysis device 100 of the first embodiment. The photoanalysis device 100 is set to operate at an excitation wavelength of 642 nm, an excitation intensity of 1 mW and 0.9 mW, an observation wavelength of 660 nm-710 nm, and a scanning period of 6.66 ms (scanning speed of 9000 RPM). Further, in the photoanalysis device 100, the BIN TIME is set to 10 us. From the light intensity data every second, it is set to generate two-dimensional time-series light intensity data in which 666 pieces are arranged in the one-dimensional direction and 150 cycles are arranged in the two-dimensional direction.

(Learned Model M)

In the convolution layer 32 of the learned model M of the photoanalysis device 100, three filter layers are arranged, one pooling layer is arranged, then two filter layers, and then one pooling layer is arranged. The activation function of the node is the Leaky ReLU function. In the filter layer, the input image is filtered to generate 16 types of images. The stride width of the filtering process is set to 1 pixel.

The fully connected layer 33 of the learned model M is composed of 6 layers. The activation function is the Leaky ReLU function. The activation function of the output layer 34 is the ReLU function, and the concentration (scalar value) is output.

(Teacher Data)

As teacher data, 7 samples were prepared by diluting ATTO647N to 100 aM, 320 aM, 1 fM, 3.2 fM, 10 fM, 32 fM, 100 fM using 10 mM, Tris-HCl 0.05%, and polronic F127. This was divided into 3 samples each to prepare 21 samples. In addition, as teacher data at a concentration of 0 M, 5 samples of 10 mM, Tris-HCl 0.05%, and polronic F127 were prepared, and a total of 26 samples were used for the measurement.

Each of the above 26 samples was measured with a photoanalysis device 100 at an excitation intensity of 1 mW and 0.9 mW for 600 seconds each. The 600-second time-series light intensity data of each sample was divided into 300 time-series light intensity data per second. The 300 time-series light intensity data were used as teacher data, and the remaining 300 were used as verification data.

(Learning of Learned Model M)

The learned model M was learned in advance using the above teacher data. The batch size was set to 32, mean squared error was used as the error function, and Adam was used as the optimization algorithm.

### Comparative Example 2

Comparative Example 2 is a device described in Patent Document 1 of the prior art document. This device is set to operate in the same manner as the photoanalysis device 100 except for the photoanalysis method by a computer.

(Verification Result)

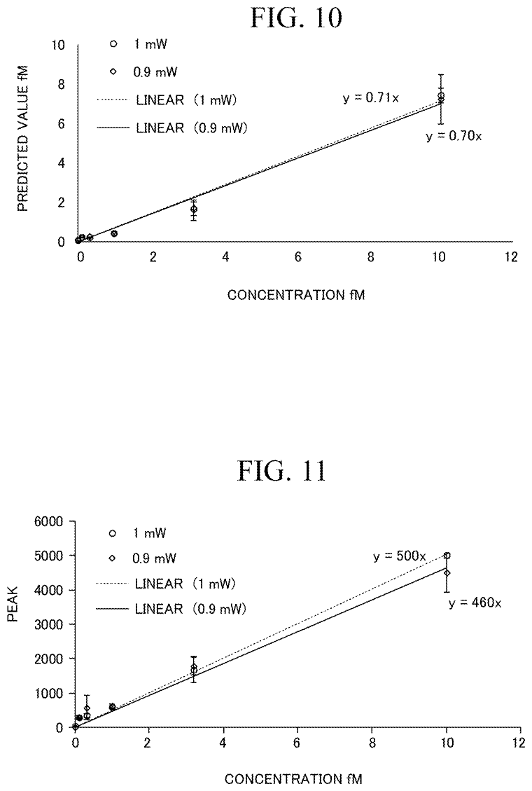

Using the above verification data, the concentration was measured and verified in Example 2 and Comparative Example 2. FIG. 10 shows the measurement results according to the second embodiment. FIG. 11 shows the measurement results according to Comparative Example 2. As a result of the measurement according to Example 2, the difference in slope was small at the excitation intensities of 1 mW and 0.9 mW, and the amount of the signal was maintained at 99% (0.70/0.71) even when the excitation intensities decreased to 90%. On the other hand, in Comparative Example 2, the amount of signal decreased to 92% (460/500). In Example 2, it was shown that the measurement was robust and resistant to fluctuations in excitation intensity, as compared with the measurement results of Comparative Example 2.

The present invention can be applied to a device that performs analysis by scanning.

What is claimed is:

1. A photoanalysis device comprising:
an optical system configured to scan a sample solution to detect light-emitting particles that are scattered in a sample solution and move randomly;
a light detection data input part into which light detection data, which is a result of detection of the light-emitting particles by the optical system, is input;
a signal processor configured to generate time-series light intensity data from the light detection data;
a concentration calculator configured to calculate a concentration of the light-emitting particles detected by the optical system, from the time-series light intensity data generated by the signal processor, on the basis of a learned model learned about a relationship between a plurality of time-series light intensity data having different measurement conditions and a concentration of the light-emitting particles; and
a concentration output part configured to output a calculation result of the concentration calculator,
wherein the signal processor configured to generate two-dimensional time-series light intensity data arranged in time order in one-dimensional direction and periodic order in two-dimensional direction from the time-series light intensity data, and
the learned model of the concentration calculator configured to input the two-dimensional time-series light intensity data.

2. The photoanalysis device according to claim 1, wherein the learned model is composed of a neural network, the neural network is configured to input the time series light intensity data, and the neural network outputs the concentration of the light-emitting particles.

3. The photoanalysis device according to claim 2, wherein the neural network is a convolutional neural network, and the two-dimensional time-series light intensity data is input to the convolutional neural network as an image.

4. The photoanalysis device according to claim 1, further comprising:
a measurement condition input part that configured to input a measurement condition when the light detection data is detected,
wherein the learned model has been learned regarding a relationship between the time-series light intensity data, the measurement condition, and the concentration of the light-emitting particles, and
the concentration calculator calculates the concentration of the light-emitting particles from the time-series light intensity data and the measurement conditions on the basis of the learned model.

5. The photoanalysis device according to claim 4, wherein the measurement condition is at least one of diffusion time, brightness, presence/absence of non-analyzed object, scanning period, excitation wavelength, excitation intensity, and observation wavelength of the molecular species.

6. A photoanalysis method comprising:
a scanning detection step that detects light-emitting particles scattered in a sample solution and moving randomly by scanning an optical system;
a time-series light intensity data generation step that generates time-series light intensity data from a light detection data which is a detection result of the light-emitting particles;
a time-series light intensity data two-dimensional step that generates two-dimensional time-series light intensity data arranged in time order in a one-dimensional direction and periodic order in a two-dimensional direction from the time-series light intensity data; and
a concentration calculation step that calculates a concentration of the light-emitting particles from the time-series light intensity data on the basis of a learned model learned about a relationship between a plurality of the time-series light intensity data having different measurement conditions and the concentration of the light-emitting particles.

7. The photoanalysis method according to claim 6, further comprising:
a measurement condition input step in which a measurement condition when the light detection data is detected is input,
wherein the learned model has been learned regarding a relationship between the time-series light intensity data, the measurement condition, and the concentration of the light-emitting particles, and
the concentration calculation step calculates the concentration of the light-emitting particles from the time-series light intensity data and the measurement condition on the basis of the learned model.

8. A neural network system capable of executing a learned model for operating a computer to output a concentration of light-emitting particles on the basis of time-series light intensity data of the light-emitting particles,
wherein the learned model consists of a convolutional neural network,
two-dimensional time-series light intensity data generated from the time-series light intensity data and arranged in time order in one-dimensional direction and periodic order in two-dimensional direction is input as an image to an input layer of the convolutional neural network, and the concentration of the light-emitting particles is output from an output layer of the convolutional neural network.

9. The neural network system according to claim 8, wherein the learned model makes a computer function so as to input the two-dimensional time series light intensity data and a measurement condition of the light-emitting particles into the input layer and output the concentration of the light-emitting particles from the output layer.
